(19) United States
(12) Patent Application Publication
(10) Pub. No.: US 2011/0006559 A1
(43) Pub. Date: Jan. 13, 2011

(54) METHOD OF MAKING A BODY FOR A MOTOR VEHICLE, AND BODY OF A MOTOR VEHICLE

(75) Inventors: JOHANNES SCHÄFERS, Borchen (DE); Ulrich Lütke-Bexten, Paderborn (DE); Markus Kettler, Paderborn (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/829,713

(22) Filed: Jul. 2, 2010

(30) Foreign Application Priority Data
Jul. 9, 2009 (DE) 10 2009 032 651.0

(51) Int. Cl. B62D 33/00; B21D 53/88; B23K 26/00; B32B 7/08

(52) U.S. Cl. 296/181.1; 29/897.2; 219/121.72; 156/92

(57) ABSTRACT

In a method of making a body for a motor vehicle, shaped components are produced from blanks using at least one forming process. The shaped components are provided with rivet holes, and a coating is applied onto the shaped components for corrosion protection. After applying the corrosion protection, the shaped components are joined with the body via rivets.

### CROSS-REFERENCES TO RELATED APPLICATIONS

This application claims the priority of German Patent Application, Serial No. 10 2009 032 651.0, filed Jul. 9, 2009, pursuant to 35 U.S.C. 119(a)-(d), the content of which is incorporated herein by reference in its entirety as if fully set forth herein.

### BACKGROUND OF THE INVENTION

The present invention relates, in general, to a body for a motor vehicle, and more particularly to a method of making a body for a motor vehicle.

The following discussion of related art is provided to assist the reader in understanding the advantages of the invention, and is not to be construed as an admission that this related art is prior art to this invention.

Automotive parts, in particular components of the vehicle body and reinforcements for the body, must comply with stringent standards as far as stiffness and strength are concerned. At the same time, these parts should have a smallest possible material thickness so as to reduce weight. High strength steel and super high strength steel are typically used in particular for producing reinforcements. Normally, these reinforcements are made by a hot-forming process, in which a blank, cut to size beforehand, is heated and then formed in a particular forming tool and hardened. Such a process is disclosed, for example, in German Offenlegungsschrift DE 100 49 660 A1.

International publication WO 2005/018848 A1 discloses the application of a coating to protect a component against corrosion after the component underwent a hardening process.

Vehicle bodies are typically reinforced, using reinforcements which are joined to the body by spot welding. A drawback associated therewith is for example that aluminum-silicon or zinc powder coatings cannot be applied before welding because of the risk of hydrogen embrittlement as a result of their great layer thickness and galvanization.

It would therefore be desirable and advantageous to provide an improved method of making a body for a motor vehicle to obviate prior art shortcomings and to allow shaped components to be flatly coated, and to provide an improved body which can be coated with a protective coating against corrosion also in the connection zone.

### SUMMARY OF THE INVENTION

According to one aspect of the present invention, a method of making a body for a motor vehicle includes the steps of producing shaped components from blanks using at least one forming process, providing the shaped components with rivet holes, applying a coating onto the shaped components for corrosion protection, and joining the shaped components with the body via rivets after the applying step.

The manufacture of a body for a motor vehicle involves the use of shaped components to reinforce the body. The shaped components are hereby made from blanks of steel sheet through at least one forming process. Subsequently, the shaped components receive a coating for corrosion protection. The rivet holes are provided in the shaped components before applying the coating and are used to join the shaped components with the body by means of rivets.

According to another advantageous feature of the present invention, the rivet holes can be provided in flanges of the shaped components during a first stage of the forming process. In other words, the blanks can be shaped by a two-stage process, involving a cold preforming process and a hot-forming process following the cold preforming process. The flanges are shaped during the preforming process, with the rivet holes being also provided during the preforming process. Thereafter, the pre-formed components are hardened with the rivet holes through conventional hot forming. The steel sheet is hereby austenitized at a material-specific austenitizing temperature in the range of 950° C. Rapid quenching takes place during the forming process, whereby the material structure leaves the austenitic state and receives a martensitic microstructure as a consequence of a cool down to temperatures between 100° C. and 200° C., resulting in high strength components.

When forming the blanks into the shaped components through a single-step hot-forming or press-hardening process, the rivet holes are provided after the forming process through laser beam cutting or cold cutting.

As an alternative, the shaped components may also be manufactured from the blanks by a roll-forming process. Roll-forming is a continuous forming process in which band material of steel sheet is shaped to the desired component step-by-step. The rivet holes can be incorporated during or after the flanges have been formed.

The hardened components may subsequently undergo a paintjob or may be powder-coated in order to provide a protective coating against corrosion across the entire surface, i.e. also in the area of the rivet holes.

The shaped components can be joined with the body by rivets, such as solid rivets. To enhance the joining strength, riveting of the shaped components and body may be supplemented by gluing.

Eliminating the need for welding spots by replacing them with rivets allows a coating of the shaped components across their entire surface before being joined with the body. In addition, three welding spots can be replaced by two rivets while still maintaining a same strength of the connection.

Examples of the coating may include aluminum-silicon coatings, zinc-powder coatings, or zinc coatings. A benefit of a method according to the invention resides in particular in a superior corrosion protection also in the joining zone. In addition, the manufacturing process and the production costs can be optimized because the shaped components can be coated immediately after press-hardening and then transported to other facilities for assembly for example.

When joining uncoated components with the body, the coating step occurs after joining, requiring either a new transport for coating or operation of an on-site coating plant. Both these options can be streamlined through incorporation of the coating process in the manufacturing process of the shaped components.

The method according to the present invention enables the manufacture of a body for a motor vehicle, having shaped components for reinforcement of the body, with the components being coated with a protective layer against corrosion across their entire surface. The components are hereby joined with the body via rivets. The rivets are arranged in rivet holes in the flanges of the shaped components, and the shaped components have been coated with a powder coating or painted with a protective layer against corrosion before being riveted to the body.

In addition to the riveted connection, the components may also be glued with the body.

According to another aspect of the present invention, a body for a motor vehicle includes shaped components having rivet holes via which the shaped components are joined with the body.

According to another advantageous feature of the present invention, the shaped components can be made of a hot-formed steel.

### BRIEF DESCRIPTION OF THE DRAWING

NONE

### DETAILED DESCRIPTION OF PREFERRED EMBODIMENTS

NONE

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of making a body for a motor vehicle, comprising the steps of:
producing shaped components from blanks using at least one forming process;
providing the shaped components with rivet holes;
applying a coating onto the shaped components for corrosion protection; and
joining the shaped components with the body via rivets after the applying step.

2. The method of claim 1, wherein the forming process is a roll-forming process.

3. The method of claim 1, wherein the rivet holes are provided in flanges of the shaped components during a first stage of the forming process.

4. The method of claim 3, further comprising the step of subjecting the shaped components to a hot-forming process after the first stage of the forming process.

5. The method of claim 1, further comprising the step of subjecting the shaped components to a hot-forming process, wherein the rivet holes are provided in flanges of the shaped components after the hot-forming process.

6. The method of claim 1, wherein the rivet holes are produced by laser beam.

7. The method of claim 1, wherein the rivet holes are produced by a cold-cutting process.

8. The method of claim 1, wherein the joining step includes gluing.

9. A body for a motor vehicle, comprising shaped components having rivet holes via which the shaped components are joined with the body.

10. The body of claim 9, wherein the shaped components are made of hot-formed steel.

11. The body of claim 9, wherein the rivet holes are provided in flanges of the shaped components.

12. The body of claim 9, wherein the shaped components have a powder coating.

13. The body of claim 9, wherein the shaped components are painted.

14. The body of claim 9, wherein the shaped components are riveted and glued with the body.
